(19) United States
(12) Patent Application Publication
(10) Pub. No.: US 2012/0177917 A1
(43) Pub. Date: Jul. 12, 2012

(54) IDENTIFICATION AND INFORMATION CONCEALING ADHESIVE BACKED LABEL

(76) Inventor: CAROLANNE MARIE STANISLAW, Grand Rapids, MI (US)

(21) Appl. No.: 12/985,599

(22) Filed: Jan. 6, 2011

(51) Int. Cl. B32B 7/12

(52) U.S. Cl. 428/343

(57) ABSTRACT

A label to adhere to a card surface or object to conceal its identification and information. The label has a semipermanent adhesive on the backside surface to achieve adhesion to a surface. The label will be thin, not affecting the use or performance of the card or object it is adhered to. The semipermanent adhesive used on the label will be made of a durable material for use, but one that allows easy removal of the label while leaving behind no residue. The label will provide privacy to all sectors and provide freedom to the low income and disabled who use government issued cards that have easily identifiably features; from the stigma and discrimination often associated with being of low economic status, disabled or both. The label will be manufactured with recyclable material, making it environmentally friendly. Being economically priced, the user can change labels frequently.

### FIELD OF INVENTION

The present invention deals with semipermanent adhesive backed labels that are designed to provide privacy to a card or object by adhering the label to a card or object to cover the desired and selected information for concealment, but not affecting the intended use of the card or object. The label will be made from recyclable materials, making it environmentally friendly.

### BACKGROUND OF INVENTION

For many years cards such as debit cards, food benefit cards and, but not limited to credit cards and objects are used openly exposing private identification and information. Identity theft, unlawful use of a card, safety, discrimination and privacy issues are a serious risk to all. To assist and provide a solution to the problem of exposed information and identifying features, a semipermanent, durable adhesive label will protect and conceal the information bearing surface, while maintaining the capabilities and intended use of the card or object. The adhesive label will have a durable adhesive on the backside surface that facilitates and allows the label to be adhered to a card or object and the opposite side, being the front side surface of the label, will not have adhesive, but will obstruct and cover the information that is desired to be made private.

The adhesive label will provide freedom and privacy to the public sector by allowing them to openly use cards or objects without fear of becoming a victim of information theft. Another favorable attribute of the adhesive backed privacy label is giving the low income and disabled who use government issued food benefit, medicaid and other cards that bear specific identifying markers a way to conceal the type of card, freeing themselves from the stigma and discrimination often associated with being of low economic status, disabled or both, while maintaining the ability to use the card.

The adhesive label will be manufactured in all sizes, colors, designs, to give the labels a personal, artist flare and if desired a glow in the dark feature to help locate the item containing the label in the dark.

### SUMMARY OF INVENTION

An adhesive backed semipermanent removable label to conceal and make private information on cards and objects that one chooses not to disclose, providing freedom to use such cards or objects openly without the risk of information theft or discrimination.

### BRIEF DESCRIPTION OF DRAWINGS

FIG. 1 Is a perspective view of the adhesive backed label showing the front surface layer and the back surface layer containing the adhesive.

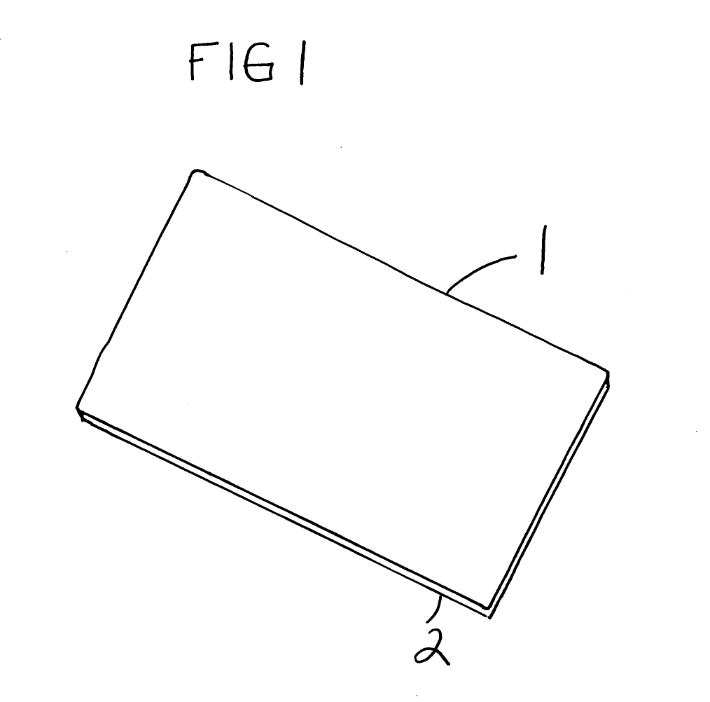

What is claimed:

1. A label constructed from a durable material resistant to damage from the elements and use that has a semipermanent adhesive on the back side surface of the label to secure and attach the label to an object, to cover and conceal the information bearing surface, protecting and providing privacy while not interfering with the use of the object, the label is removable, leaving behind no adhesive residue on the object in which it is applied, being made in all sizes, shapes, colors, designs, textures, including glow in the dark capability and made from synthetic or natural material or a combination of synthetic and natural material that cuts easily for adaptation to the consumer's specific size need.
